(19) United States
(12) Patent Application Publication
(10) Pub. No.: US 2004/0065448 A1
(43) Pub. Date: Apr. 8, 2004

(54) Horn for fire extinguisher

(76) Inventor: Stephen Timothy Zahan, Shepshed (GB)

Correspondence Address: Andrew R Basile, Young & Basile, Suite 624, 3001 West Big Beaver Road, Troy, MI, 48084, US

(21) Appl. No.: 10/433,559

(22) PCT Filed: Dec. 11, 2001
(86) PCT No.: PCT/GB01/05473

(30) Foreign Application Priority Data
Dec. 12, 2000 (GB) 0030212.5

(51) Int. Cl. A62C 11/00

(52) U.S. Cl. 169/30; 239/589; 239/592; 239/601

(57) ABSTRACT

The invention provides a fire extinguisher horn having an inner tube, through which gas may pass from the nozzle of the fire extinguisher to the atmosphere, and an outer tube surrounding the inner tube to form a chamber around the inner tube along at least part of its length. The chamber provides an insulating space between the inner and outer tubes so that, although the inner tube may become very cold in use as the extinguisher gas expands through it, the outer surface of the outer tube remains closer to the ambient temperature. Thus, it is possible to hold the extinguisher horn safely. Preferably, the horn further comprises apertures that allow atmospheric air to flow through the chamber when the extinguisher is in use, maintaining the temperature of the chamber and, hence, of the outer tube close to the ambient air temperature.

A common type of fire extinguisher contains pressurized carbon dioxide gas, which can be used to extinguish a fire by depriving it of the oxygen required for combustion. CO₂ extinguishers are especially suited to electrical fires, for which water cannot be used, and they cause much less damage than extinguishers that use water, foam or powder to smother the flames. The carbon dioxide gas emerges from the gas cylinder of the extinguisher through a nozzle and is directed towards the fire by a horn surrounding the nozzle. The present invention relates to improvements in such horns.

When a CO₂ fire extinguisher is activated, the expansion of the gas emerging from the nozzle causes it to cool dramatically as the pressure decreases. This in turn cools the horn through which the gas is directed. In tests of a typical hand-held CO₂ fire extinguisher, the horn was found to cool within a view seconds from an initial, ambient temperatures of +19° C. to below −47° C. For this reason, the horn must not be held in the hand during use of the extinguisher and all CO₂ fire extinguishers carry a warning accordingly. However, in the emergency conditions of a fire, users frequently do not pause to read the instructions or recall any training that they may have been given so they revert to the natural action of holding the horn to point it towards the flames. As a result, many “cold burn” injuries to hands are caused each year by the misuse of CO₂ fire extinguishers.

There exists a particular problem with common design of CO₂ fire extinguisher, in which the horn and nozzle are located at the end of a rigid pipe. Normally, to save space, the horn is stowed parallel to the gas cylinder but it can be moved to the desired angle for use by rotating the pipe about a sealed connector. Friction in the connector should retain the horn in position, but damage or wear to the seal can reduce the friction so that the horn does not remain at the desired angle. In this situation, it is still more likely that a user will hold the horn in the hand to direct it towards the fire, thereby risking injury.

In some known CO₂ fire extinguishers, the horn as an integral handle by which it can be held, thereby distancing the user's hand from the coldest part of the horn. This arrangement is used especially in heavier models of extinguisher that are not designed to be handheld but to rest on the ground, the nozzle and horn being located at the end of a flexible pipe. However, the handles do not actually prevent contact with the coldest part of the horn and the handles tend to become broken. Breakage is likely to be a still greater problem for small, handheld extinguishers because the handle may not be strong enough to take the full weight of the extinguisher.

The invention provides a fire extinguisher horn, comprising: means for attaching the horn to the nozzle of a fire extinguisher; an inner tube, through which gas may pass downstream from the nozzle of the fire extinguisher to the atmosphere; and an outer tube surrounding the inner tube and spaced therefrom to form a chamber around the inner tube along at least part of its length.

The chamber provides an insulating space between the inner and outer tubes so that, although the inner tube may become very cold in use, the outer surface of the outer tube remains closer to the ambient temperature. Thus it is possible to hold the extinguisher horn safely.

In this specification, the word “upstream” is used to indicate the end of the horn nearer to the nozzle attachment means and the word “downstream” is used to indicate the end of the horn further from the nozzle attachment means.

Also in accordance with the present invention there is provided a fire extinguisher horn comprising: means for attaching the horn to the nozzle of a fire extinguisher; an inner tube, through which gas may pass downstream from the nozzle of the fire extinguisher to the atmosphere; and an outer tube surrounding the inner tube and spaced therefrom to form a chamber around the inner tube along at least part of its length, at least one upstream aperture that allows air to flow from the atmosphere into the upstream end of the chamber closer to the nozzle attachment; and at least one downstream aperture that allows air to flow from the downstream end of the chamber into the atmosphere.

This arrangement leads to a constant flow of atmospheric air through the chamber when the extinguisher is in use, as the gas emerging from the downstream end of the horn entrains a parallel flow of air. Because the air in the chamber is constantly replenished with air at ambient temperature from the upstream end of the chamber, the temperature of the chamber and hence of the outer tube remains close to the ambient air temperature and the horn is safe to hold.

There is a further advantage, which may increase the efficiency of the horn is comparison with the prior art. In the prior art, the low temperature of the horn can lead to the build-up of water and carbon dioxide ice on its surfaces, these gases freezing out from the atmospheric air or from the extinguisher gas itself. An excessive build-up of ice can impede the flow of gas and thereby reduce the efficiency of the extinguisher. In the present invention, the flow of ambient air through the chamber maintains the whole of the horn at a higher temperature during use than the prior art, so there will be less build-up of ice on the surfaces of the horn. The airflow also helps to reduce the build-up of static electricity, which is a common problem with fire extinguisher horns.

In a preferred embodiment of fire extinguisher horn according to the invention, the outer tube is formed separately from the inner tube. A flange extends outwards from the downstream end of the inner tube to form a downstream end wall of the chamber. The outer tube has at least one inward projection, which engages the flange of the inner tube to retain the outer tube in position around the inner tube. Each of the inner and outer tubes may have a generally frustoconical shape, the inner and outer tubes being concentric in the assembled horn.

It will be apparent that the invention may be applied to fire extinguishers containing gases other than carbon dioxide that suppress combustion. More generally, it can be applied to any other situation in which a gas creates cooling by being expanded through a handheld nozzle.

The invention will now be described further by way of example with reference to the accompanying drawings in which:

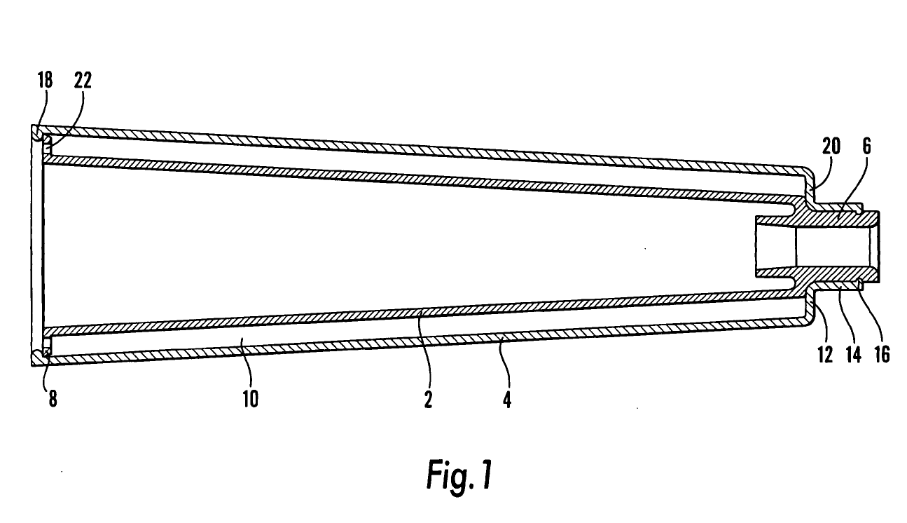

FIG. 1 is a longitudinal section through a fire extinguisher horn according to the invention.

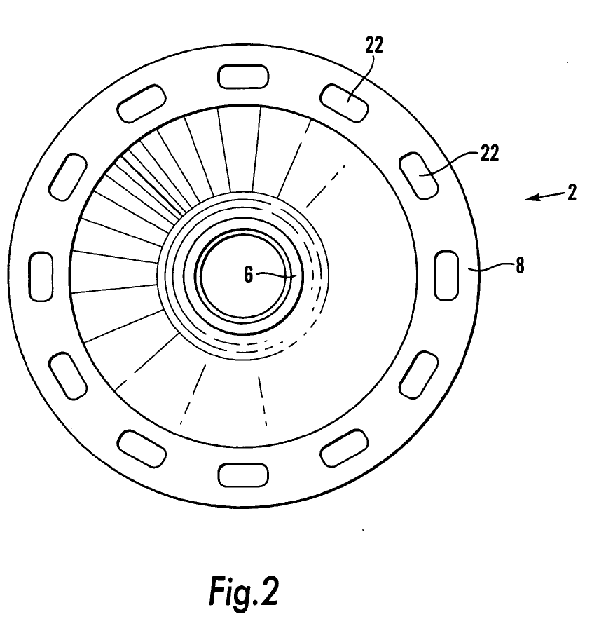

FIG. 2 is an end view of the inner tube of the fire extinguisher horn shown in FIG. 1.

FIG. 1 shows an inner tube 2 and an outer tube 4 assembled to form a fire extinguisher horn. The inner tube 2 has a shape similar to conventional fire extinguisher horns. At one end (the upstream end) there is a means 6 for attaching the horn to the nozzle of a CO₂ fire extinguisher. The inner tube 2 has a circular cross-section, which gradually increases in area towards the downstream end of the tube. Around the outer surface of the inner tube 2 at its downstream end is an integral, radial, circular flange 8, which is also shown in FIG. 2. The outer tube 4 generally has the shape of a truncated circular cone of larger diameter than the inner tube 2. Thus, when the outer tube 4 is placed concentrically around the inner tube 2, a conical chamber 10 is formed between them, with a uniform thickness in the radial direction. The upstream end of the outer tube 4 has a shoulder 12 and a narrower neck 14, which fits tightly around the nozzle attachment 6 of the inner tube 2. In the illustrated embodiment, the neck 14 of the outer tube 4 has an inwardly projecting lip 16, which locates in a corresponding groove on the inner tube 2 to inhibit axial movement between the inner and outer tubes 2,4. The downstream end of the outer tube 4 also has an inwardly projecting lip 18, behind which the flange 8 of the inner tube 2 locates to inhibit relative movement between the inner and outer tubes 2,4.

The upstream end wall of the chamber 10 is formed by the shoulder 12 of the outer tube 4. Circumferentially spaced around it are several upstream apertures 20, which allow a flow of air from the atmosphere into the chamber 10. The downstream end wall of the chamber 10 is formed by the flange 8 of the inner tube 2. Circumferentially spaced around it are several downstream apertures 22 (also seen in FIG. 2) which allow a flow of air from the chamber 10 to the atmosphere.

In use, the assembled horn is attached via means 6 to the nozzle of a CO₂ fire extinguisher. The extinguisher is operated and CO₂ gas flows through the horn to emerge at the downstream end. The gas flowing through the horn expands as it leaves the horn. This creates a vortex at the downstream end of the horn creating a low pressure zone which in turn draws ambient air into the chamber 10 via the upstream apertures 20 and to exit the chamber 10 via the downstream apertures 22. This flow of atmospheric air maintains the chamber 10 and hence the outer tube 4 close to ambient temperatures so that the outer tube 4 is safe to be held in the hand of a user. This cooling air flow through the chamber 10 is a very important aspect of the invention.

The CO₂ gas leaving the downstream end of the inner horn 6 does so with a lamina flow. After a short period of time the velocity of the air being drawn through the chamber 10 builds up to a similar velocity as that of the CO₂ gas in the inner horn 6. It is believed that the flow of air around the lamina flow of CO₂ gas assists in maintaining the flow of CO₂ gas in its lamina state. However, at some distance spaced from the downstream end of the horn, the lamina flow becomes turbulent. By extending the period, and thus the distance, of the lamina flow state of the CO₂ gas, the horn is more efficient in extinguishing a fire since the CO₂ gas flow is more directed during the extended period.

The inner and outer tubes 2, 4 must be made of a material that can withstand both high temperatures (for use near fires) and low temperatures (because of the cooling effect of the expanding CO₂ gas) and that is a poor conductor of heat (to minimize heat flow from the warmer outer tube 4 to the cold inner tube 2). One suitable material is PP Copol Fire retardant plastic, which is free of heavy metals. However, other materials may also be used and the inner and outer tubes 2, 4 need not be of the same material.

The illustrated embodiment of fire extinguisher horn is assembled from the two plastics mouldings while they are still warm and sufficiently deformable for the lip 18 of the outer tube 4 to pass over the flange 8 of the inner tube 2. Once the assembled horn has cooled, it is not possible to separate the inner and outer tubes 2, 4. However, fire extinguisher horns according to the invention may be manufactured in other ways that will be apparent to the skilled reader, including manufacture in a single piece. The end walls of the chamber 10 need not be integral with the inner and outer tubes 2,4 in the manner described above but this configuration is preferred for ease of manufacturing the respective components. One simple change would be to replace the continuous flange 8 of the inner tube 2 by an array of radial projections, such that the gaps between the projections formed the downstream apertures 22.

It is not essential for the chamber 10 to extend over the whole length of the horn or, indeed, around the whole of its circumference, provided that there is a sufficient insulated surface area for the user to hold. The horn may be provided with a handle or be shaped to increase the user's grip and locate the hand in a desired position.

1. A fire extinguisher horn, comprising: means for attaching the horn to the nozzle of a fire extinguisher; an inner tube, through which gas may pass downstream from the nozzle of the fire extinguisher to the atmosphere; and an outer tube surrounding the inner tube and spaced therefrom to form a chamber around the inner tube along at least part of its length.

2. A fire extinguisher horn, comprising:means for attaching the horn to the nozzle of a fire extinguisher; an inner tube, through which gas may pass downstream from the nozzle of the fire extinguisher to the atmosphere; and an outer tube surrounding the inner tube and spaced therefrom to form a chamber around the inner tube along at least part of its length, at least one upstream aperture that allows air to flow from the atmosphere into the upstream end of the chamber closer to the nozzle attachment; and at least one downstream aperture that allows air to flow from the downstream end of the chamber into the atmosphere.

3. A fire extinguisher horn according to claim 3, comprising a plurality of the downstream apertures spaced around the circumference of the horn.

4. A fire extinguisher horn according to any preceding claim, wherein a flange extends outwards from the downstream end of the inner tube to form a downstream end wall of the chamber.

5. A fire extinguisher horn according to claim 4, wherein the outer tube is formed separately from the inner tube; and wherein the tube has at least one inward projection, which engages the flange of the inner tube to retain the outer tube in position around the inner tube.

6. A fire extinguisher horn according to any preceding claim, wherein the means for attachment to the nozzle of a fire extinguisher is integral with the inner tube.

7. A fire extinguisher horn according to any preceding claim, wherein each of the inner and outer tubes has a generally frustoconical shape, the inner and outer tubes being concentric.
